(19) United States
(12) Patent Application Publication
(10) Pub. No.: US 2020/0045900 A1
(43) Pub. Date: Feb. 13, 2020

(54) SINGLE-PIECE FLOATING TRAY FOR HYDROPONIC CULTIVATION

(71) Applicants: Damiano GHIRLANDA, Verona (IT); Martino GHIRLANDA, Modena (IT)

(72) Inventors: Damiano GHIRLANDA, Verona (IT); Martino GHIRLANDA, Modena (IT)

(21) Appl. No.: 16/605,788

(22) PCT Filed: Apr. 24, 2018
(86) PCT No.: PCT/IB2018/052857

§ 371 Date: Oct. 16, 2019

(30) Foreign Application Priority Data
Apr. 27, 2017 (IT) 102017000045518

(51) Int. Cl. A01G 31/06; A01G 9/02

(52) U.S. Cl. CPC A01G 31/06; A01G 9/028

(57) ABSTRACT

A single-piece tray for hydroponic cultivation, composed of a plastic material shaped to define identical cultivation cells inside the tray. Each cultivation cell has: a housing defining a raised plane and configured to house a bulb or seedling to be cultivated, with a hole dimensioned to support the bulb or seedling without letting it fall through, while allowing its roots to protrude below the tray; a buoyant portion, defining a lowered plane intended to sink below a waterline, and delimited by side walls, each buoyant portion defining: a bottomside with a first height, a waterline zone with a second height, a topside with a third height; the sum of the first, second and third heights corresponding to the height of the side walls which connect the raised plane to the lowered plane. The side walls forming a channel.

### TECHNICAL FIELD

The present disclosure relates to the apparatus used for hydroponic cultivation and more particularly to a single-piece floating tray for hydroponic cultivation.

### BACKGROUND

Hydroponic cultivation is a technique for performing soilless cultivation where the plants to be cultivated are irrigated with a nutritive chemical solution composed of water and the compounds needed to provide all the elements indispensable for normal mineral nutrition. Typically the plants are placed on a support arranged on the surface of the water or above it, the support being provided with holes through which the roots of the plant protrude so as to be immersed in the water.

Supports of this type are for example disclosed in the document EP167638 which illustrates a floating support for hydroponic cultivation, having a pad of hydrophobic material provided with through-holes, for allowing the roots which are growing to protrude, having small dimensions so as to favour capillary attraction.

### SUMMARY

The Applicant has noted a drawback of this support and of other known supports for hydroponic cultivation which consists in the fact that these supports are not suitable for housing bulbs or seedlings for the time needed for them to become completely mature plants. More particularly, the Applicant has noted that on the market today there exist floating supports, mainly for seed boxes, in which the bulb is in direct contact with the aqueous solution. As the plant grows and gains weight, the bulb becomes immersed in the said solution, with a considerable increase in the risk of rotting. In fact it has been noted that often it is required to remove the plants from these supports before they reach maturity in order to avoid the risk of rotting. Examining the causes which led to crop losses, the Applicant noted that, whilst growing, the plants which were not yet mature caused the support to sink too much because of their increased weight, moving so close to the water surface as to cause immersion of parts of the plant subject to rotting and preventing correct venting of the carbon dioxide produced by the roots of the said plants. These drawbacks arise even more so in hot periods where breathing of the roots is limited to only the oxygen dissolved in the water, which diminishes directly in proportion to the increase in temperature.

It has thus been understood that there exists the need to provide floating supports for hydroponic cultivations suitable for keeping the plant to be cultivated sufficiently close to the free surface of the water when the plant is relatively young, but always above the water at a minimum distance also when the plant has reached maturity, and suitable also for allowing continuous venting of the carbon dioxide produced by the roots of the plants. In fact, as a result of the support according to the present disclosure, the plant not only remains always raised above the surface of the water, but also benefits from the presence of recirculating air underneath the bulb, where the roots are able to perform their respiratory function, drawing in oxygen and eliminating carbon dioxide.

In addition, for cost-saving reasons and easier use, these supports are made as one piece and can be preferably stacked on top of each other.

In accordance with another aspect of the present disclosure, a method for hydroponic cultivation is provided whereby the plants or bulbs to be cultivated are housed inside housings of a single-piece floating tray so as to keep the roots of the plants at a minimum distance from the surface of the water and allow venting of the carbon dioxide produced by the roots.

All these objects are achieved with a single-piece floating tray for hydroponic cultivation as defined in claim 1, a use of the single-piece floating tray, and a method of hydroponic cultivation according to the respective independent claims. In particular, the entire structure of the platform, including the distance between the seats of the bulbs, the height of the platform, the through-holes for the roots, all constitute characteristics designed and optimized to ensure better oxygenation and the best possible growth of the plant in hydroponic cultivation conditions.

The claims as filed form an integral part of the present description and are incorporated herein with specific reference thereto.

Basically, a single-piece tray is provided, said tray being able to keep the plant at a distance from the water, and also a venting system for the carbon dioxide is provided between the plant and the surface of the water.

Preferably, each single-piece tray is realized by means of blow-moulding. The tray therefore has the form of a storage tank or closed casing.

### BRIEF DESCRIPTION OF THE DRAWINGS

FIG. 1 shows the inner housing side of the single-piece floating tray according to an embodiment of the present disclosure, intended to contain bulbs and seedlings to be cultivated.

FIG. 2 shows the outer side of the tray according to FIG. 1, intended to be immersed in water.

FIGS. 3 and 4 are side view of the tray shown in FIG. 1.

FIGS. 5, 6 and 7 are cross-sectional views of the tray along the lines shown in FIGS. 1 and 2.

FIGS. 8 and 9 show a view, similar to that of FIG. 6, of the single-piece floating tray placed in a tank containing water, when the plant to be cultivated is first inserted inside the tray and when the plant has fully grown, respectively.

FIG. 10 shows an alternative embodiment of the hole in a cultivation cell, with a peripheral notch.

FIG. 11 shows a top plan view of the tray according to a second embodiment.

FIG. 12 shows a top plan view of the detail II according to the embodiment of FIG. 11.

FIG. 13 shows a cross-sectional view of the detail II of FIG. 10 along the line C-C of FIG. 11.

FIG. 14 shows a cross-sectional view of the detail II of FIG. 10 along the line D-D of FIG. 11.

FIGS. 15 and 16 show a view, similar to that of FIG. 13, of the single-piece floating tray placed in a tank containing water, when the plant to be cultivated is first inserted inside the tray and when the plant has fully grown, respectively.

### DETAILED DESCRIPTION

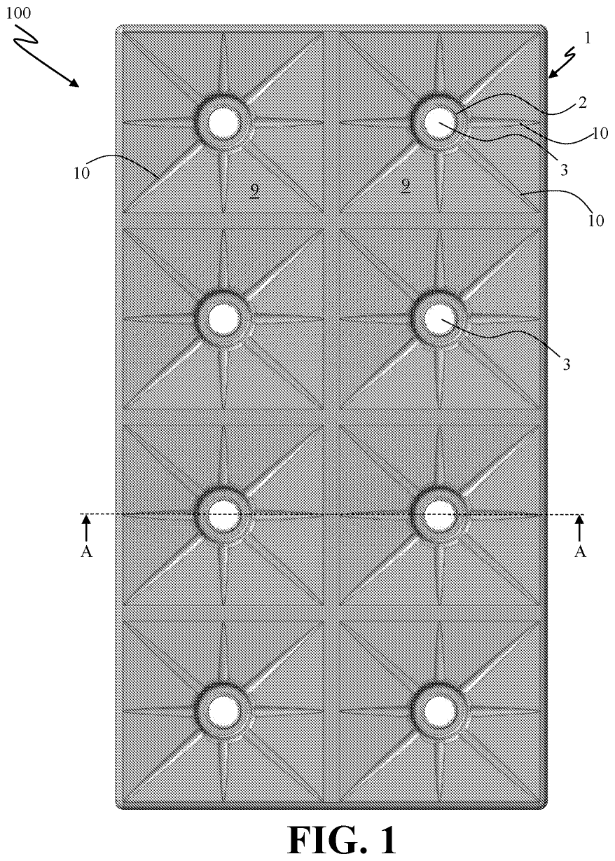

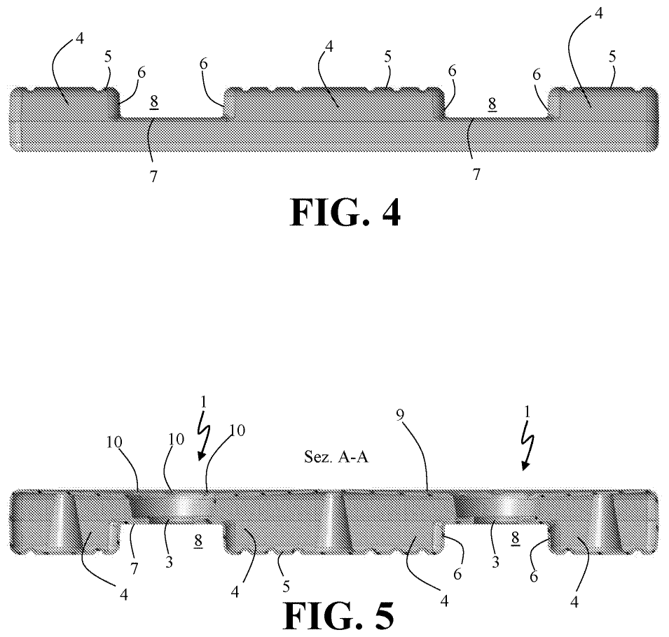

A first embodiment of a single-piece tray 100 for hydroponic cultivation according to the present disclosure is shown in FIGS. 1 to 9. It is shaped so as to define a plurality of identical cultivation cells 1.

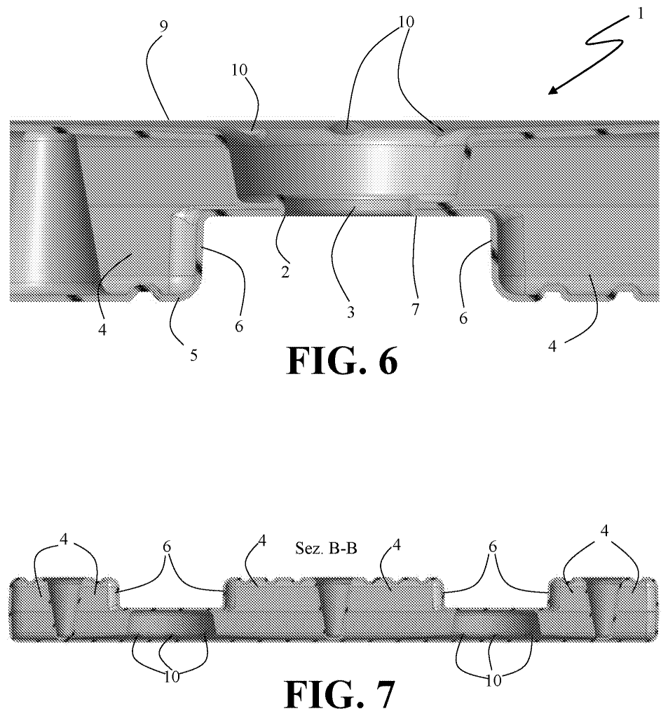

As can be understood more clearly from the cross-sectional view in FIGS. 5 and 6, each cell 1 has a housing 2 which defines a raised plane 7 and is configured to receive and support a bulb or a seedling to be grown. The housing 2 has a hole 3 with dimensions such as to support the bulb or plant to be grown without allowing it to fall through, keeping it suspended so that the roots may protrude below the tray 100 and, while growing, may become immersed in the water on which the tray 100 is floating.

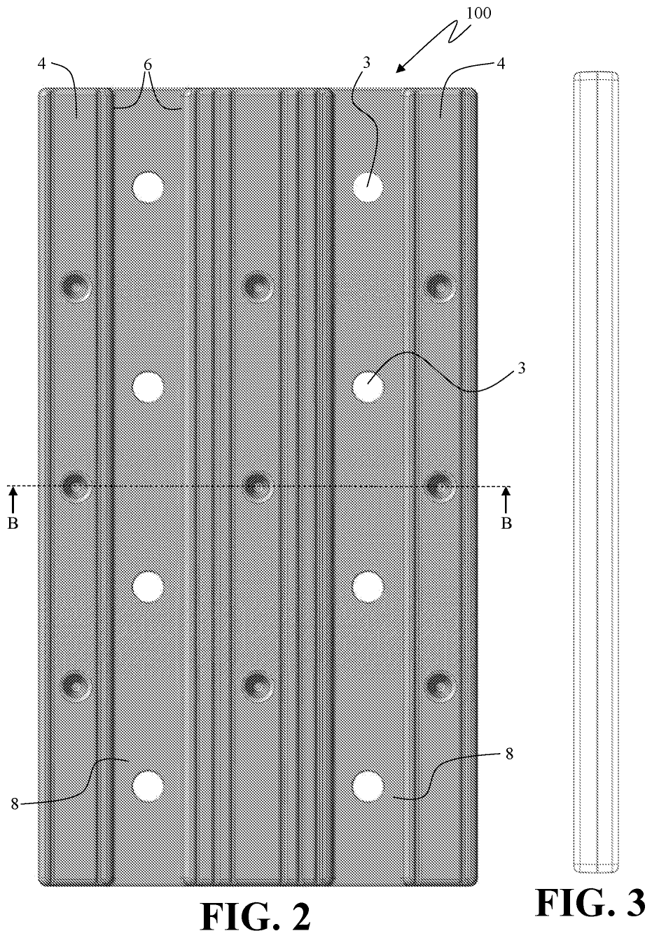

In order to be able to float in a tank filled with water, each cultivation cell has a buoyant portion 4 which defines a lowered plane 5 intended to sink below the waterline. The buoyant portions 4 are connected to the overlying housings 2 by means of side walls 6 which connect the lowered plane 5 to the raised plane 7. The side walls 6 extend as far as at least one free edge of the single-piece tray 100, defining a channel 8 which communicates with the space outside the tray 100. Preferably, as can be seen in FIG. 2, both the side walls 6 extend as far as the perimetral edges of the single-piece tray 100. In fact, the side walls 6 are not confined to the buoyant portions 4, nor do they enclose the buoyant portion so as to form a cavity confined within the single piece on all sides.

In other words, the side walls 6 define a channel 8 which communicates directly with the space outside that subtended by the tray 100, i.e. the channel 8 extends as far as an edge, or more preferably extends between opposite walls or edges of the single-piece tray, and is not limited by opposite outer walls of the tray 100.

In other words, the channel is an indentation on the side where the lowered plane is situated. The indentation extends as far as the perimeter or free edge of the tray.

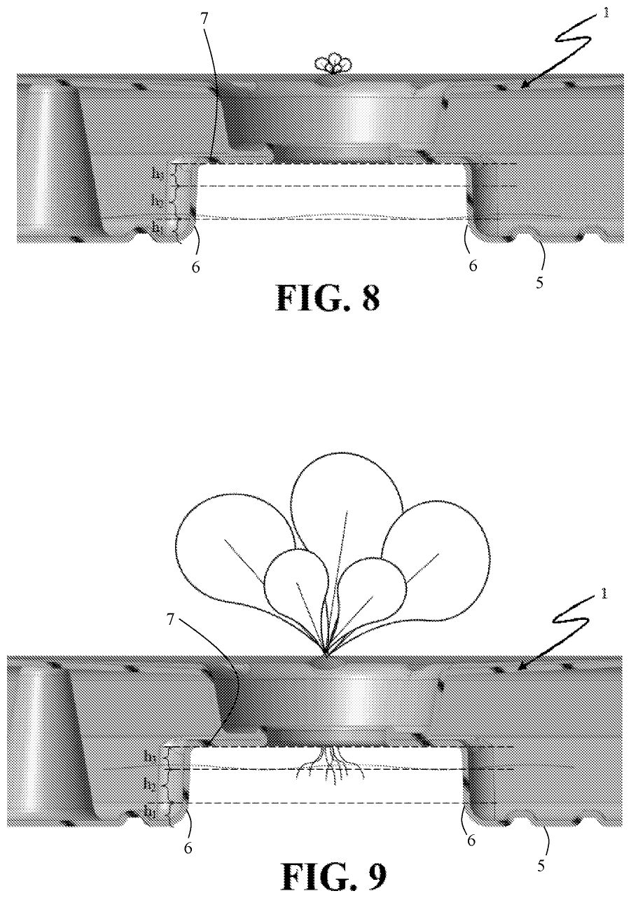

The buoyant portions have been designed to allow the tray 100 to float on the water, while maintaining a suitable distance between the seedling to be grown and the surface of the water, even when the plant has reached maturity. In greater detail, adopting the terminology used for boats, each buoyant portion for each single cultivation cell defines:
a first volume with a first height h₁, which forms the “bottomside” of the tray 100;
a second volume with a second height h₂, which forms the “waterline zone” of the tray 100;
a third volume with a third height h₃, which forms the “topside” of the tray 100;
   wherein the sum of the first height h₁, second height h₂ and third height h₃ will be equal to the height of the side walls 6 which connect the lowered plane 5 to the raised plane 7. With reference to FIGS. 8 and 9 it can be seen how the first volume is intended to remain below the waterline until a bulb or seedling to be cultivated is placed inside the respective cultivation cell. In this situation, the weight acting on the cultivation cell is minimal and corresponds to the weight of a quantity of water equal to the first volume. As the plant grows, its weight increases and consequently the tray 100 sinks more and more. When the plant reaches maturity, the second volume is also situated underneath the waterline and the weight of the mature plant corresponds to the weight of a quantity of water equivalent to the sum of the first and second volumes.

Consequently, when the plant has reached maturity, the hole 3 will be separated from the waterline by a distance equal to the aforementioned third height h₃. Since the housing 2 inside which the plant is placed until maturity remains above the waterline by at least the amount of the third height h₃, which may be defined as required, the floating tray 100 according to the present disclosure may be used for the entire duration of the cultivation without the risk of the plant rotting.

In addition, since the housing 2 in which the plant is placed always remains above the waterline, the water does not manage to occupy the entire volume subtended by the channel 8. In other words, the water does not close up the channel, but a gap or free space remains between the waterline and the housing 2. The channel 8 is therefore not filled completely by the water. In this way, it is possible to provide a passage for gas or a vent between each housing 2 and a space outside the floating tray 100.

In this way, owing to the fact also that the channel 8 communicates directly with the outside, i.e. is not further confined by the outer walls of the tray 100, the carbon dioxide produced by the plant roots is continuously vented. Advantageously this reduces the risk of rotting or suffocation of the plant roots and improves oxygenation of the water. When the bulbs or seedlings to be grown are positioned in the housings of the cultivation cells of the floating tray 100, the roots of the seedlings (or bulbs, if they have them) in general will be shorter than the sum of the aforementioned second height h₂ and third height h₃ and will not manage to reach the surface of the water on which the tray 100 floats, so that the bulb or seedling must be irrigated from above.

The housings 2 of the cultivation cells 1 are surmounted at the top by respective shelves 9 provided with holes and grooves 10. The grooves 10 of each shelf 9 with holes are arranged radially around the hole 3 of the respective housing 2 and define a slope so as to convey water sprayed on top of the cell and cause it to fall above the hole 3, irrigating the bulb or seedling placed on it.

Initially, each bulb or seedling is irrigated from above, this increasing the cultivation costs. When the roots grow, they will be immersed directly in the water on which the tray 100 is floating: irrigation from above will then be interrupted since the plant will obtain its nutrition from the roots immersed in the water.

The distance between the raised plane 7 of a housing 2 and the lowered plane 5 of the respective buoyant portion 4, which corresponds to the height of the side walls 6, is calculated so as to keep the hole 3 as close as possible to the surface of the water, in order to reduce as far as possible the irrigation time, such that the plant, when fully mature, is not drowned in water.

The dimensions of the housings 2 of the cultivation cells 1 will be determined depending on the surface area needed for the bulb or seedling to be grown. The distance between the housings 2 may depend on the product which is to be matured and this will limit the maximum number of cultivations cells 1 in each tray 100. Knowing the weight of the empty tray 100, by estimating the weight of all the bulbs and seedlings to be grown and of all the plants in the tray 100 once they have reached maturity, it will then be possible to define the buoyant portions 4 of each cultivation cell so that the aforementioned third “topside” height h₃ is greater than a minimum value, in order to prevent rotting of the plant, and so that second “waterline” height h₂ is as small as possible, so as to be able to interrupt as soon as possible irrigation of the plants from above.

According to one embodiment, the first “bottomside” height h₁ will be between 6 mm and 8 mm and preferably equal to about 7 mm; the second “waterline” height h₂ will be determined so that the sum of said height with the first “bottomside” height h₁ will be between 20 mm and 40 mm and preferably equal to 29 mm; the third “topside” height h₃ of the tray 100 will be between 6 mm and 8 mm and preferably will be equal to about 6.5 mm.

As mentioned above, below the housing 2 of each cultivation cell 1 there is defined an empty space between the raised plane of the housing 2 and the lowered plane 4 of the buoyant portion, which is sufficiently broad to allow aeration of the plant roots.

According to a non-limiting embodiment, conveniently the buoyant portions 4 of the cultivation cells 1 will be aligned in a row so as to create, underneath the holes 3, channels 8 which cross the tray 100 from one side to the other, allowing circulation of the air when the tray is floating on the water. According to an embodiment, the width of these channels is between 60 mm and 90 mm and preferably it is equal to 75 mm. If these channels 8 were not present, airtight islands would be created underneath each bulb: on the one hand this would improve the floatability of the platform and reduce the height both of the “bottomside” h₁ and of the “waterline zone” h₂, but it would adversely affect the recirculation of air for the roots underneath the seat of the bulb.

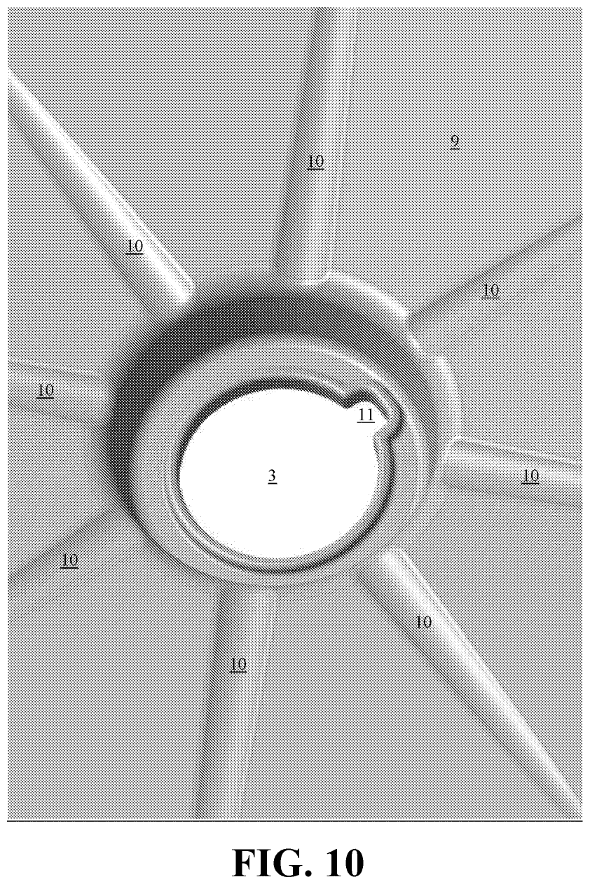

According to an embodiment shown in FIG. 10, the hole 3 of the housing 2 intended to receive the plant until it matures has a substantially circular shape with a peripheral notch 11. This notch 11 forms a further vent for facilitating the dispersion of carbon dioxide which the roots produce naturally, preventing the risk of suffocation of the plant.

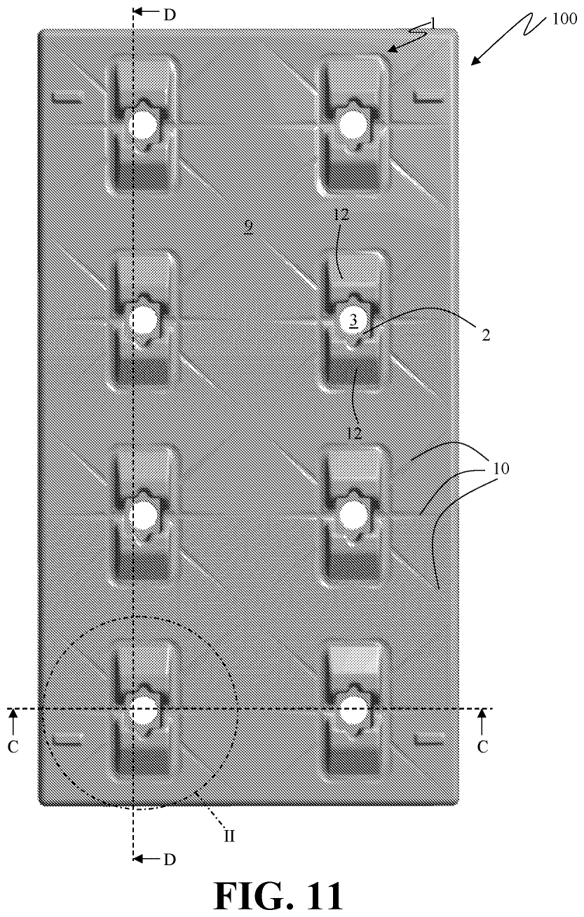

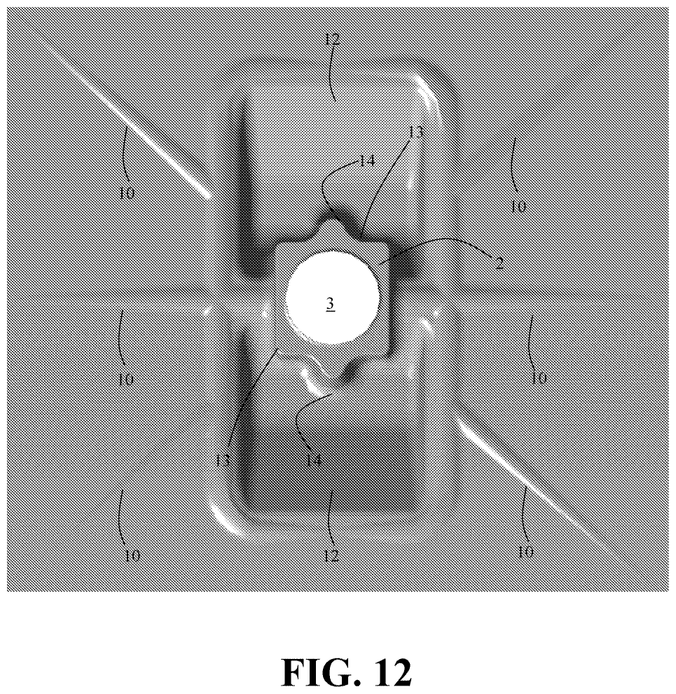

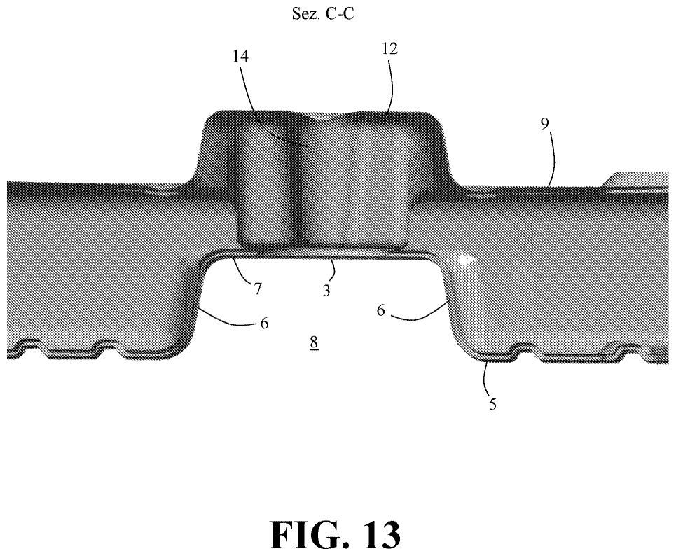

FIGS. 11-13 show a second embodiment of the single-piece tray 100 according to the present disclosure. This second embodiment differs from the first embodiment in that each housing 2 is also at least partially enclosed between protruding elements 12 which extend upwards from the surface 9 with holes of the tray 100. The protruding elements 12 are preferably separated, i.e. spaced, from each other so as to allow direct access to the housing 2 laterally and so as to allow the water from the grooves 10 to reach the hole 3 inside the housing 2. Even more preferably the protruding elements 12 are situated opposite each other relative to the housing 2 so as to retain and support the bulb or the seedling during the whole growth period. Moreover, preferably, in order to favour further supporting of the bulb or the seedling, the inner walls 13 of the protruding elements, namely the walls delimiting the housing 2, are substantially perpendicular to the raised plane 7. Finally, the inner walls 13 of the protruding elements 12 may comprise vertical grooves 14 inside which, during use, the operator is able to insert a finger when the clod is placed inside the housing 2.

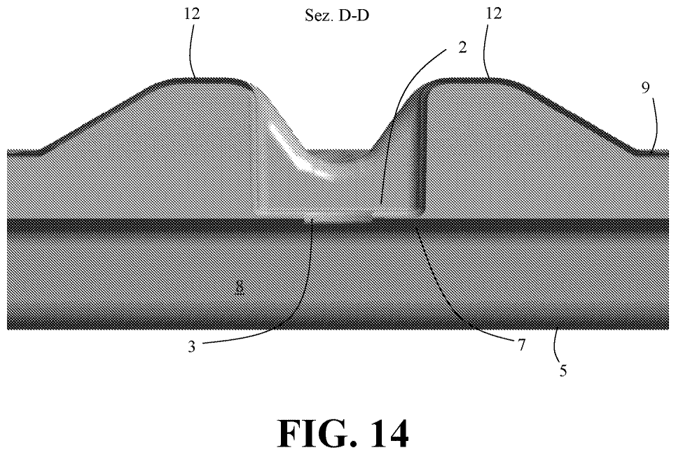

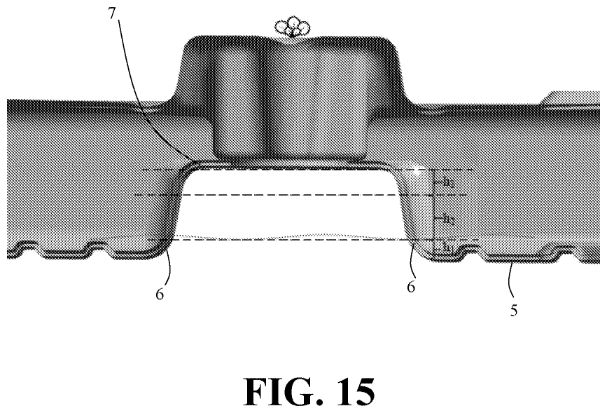

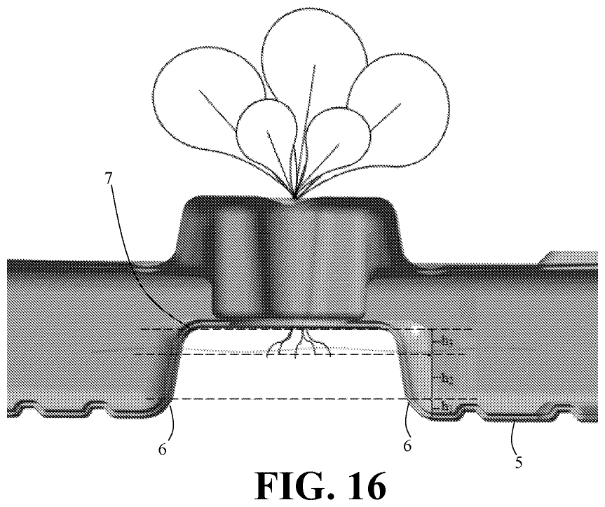

FIGS. 14 and 15 show the three heights h₁, h₂, h₃ with reference to the second embodiment.

The distance between the holes 3 of the housings 2 for the bulbs and seedlings to be grown will be conveniently calculated so as to optimize fully the useful spaces, considering also the fact that the tray 100 according to the present invention is designed to accommodate different plants. The holes 3 of the housings 2 are spaced so that, once the plants reached maturity, they are sufficiently spaced from each other so as not to hinder their natural growth.

The tray 100 for hydroponic cultivation may be easily provided with dimensions such that it can be used for different types of plant, including those which are characterized by final weights which are substantially different from each other, namely when the plants are mature and ready for harvesting. Depending on the expected final weight of the mature plant, the amount by which the trays 100 will sink below the waterline will be estimated and the height of the walls 6 determined accordingly so that the plants are not drowned in water and do not rot.

The single-piece floating tray 100 according to the present disclosure will be preferably made using a process for blow-moulding non-toxic plastic suitable for coming into direct contact with food, such as HDPE, PP, LDPE, etc. By using the blow-moulding technique it is possible to obtain, at a lower cost compared to alternative techniques (such as rotational moulding), a single-piece body in the form of a closed tank or closed casing which is internally hollow and has a broad outer surface. In fact, the single-piece floating tray 100 thus obtained is an internally hollow body, namely only air is present inside it. Advantageously, with the blow-moulding technique it is also possible to obtain walls of the single-piece tray which have a thickness of between about 1 mm and about 4 mm.

1. A single-piece tray for hydroponic cultivation, composed of a plastic material shaped to define inside the tray a plurality of identical cultivation cells, each cultivation cell having:
a housing defining a raised plane and configured to house a bulb or seedling to be cultivated, said housing having a hole with dimensions such as to support the bulb or seedling to be cultivated without letting it fall through, while allowing its roots to protrude below the tray;
a buoyant portion defining a lowered plane intended to sink below a waterline when the tray is placed on the water, said portion being delimited by side walls which extend upwards from the lowered plane and are connected to said raised plane, each buoyant portion defining:
a first inner volume with a first height, configured to remain below the waterline as soon as the bulb or seedling to be cultivated is placed in the cultivation cell,
a second inner volume with a second height, configured to remain above the waterline when the bulb or seedling to be cultivated is placed in the cultivation cell and to sink below the waterline completely when the bulb or seedling to be cultivated has become a mature plant,
a third inner volume with a third height, configured to remain above the waterline when the bulb or seedling to be cultivated has become a mature plant;
the sum of said first height, second height and third height corresponding to a height of the side walls between said raised plane and said lowered plane and wherein said side walls extend as far at least one free edge of the single-piece tray and define a channel which communicates with a space outside the single-piece tray.

2. The single-piece tray according to claim 1, wherein the side walls extend respectively towards opposite edges of the tray and said channel extends between two opposite free edges of the single-piece tray.

3. The single-piece tray according to claim 1, wherein the channel has a width of between 60 mm and 90 mm.

4. The single-piece tray according to claim 3, wherein the channel has a width of about 75 mm.

5. The single-piece tray according claim 1, wherein the housing of each of said cultivation cells is surmounted by a shelf with holes and grooves which radially branch off around the holes, said grooves defining a slope for channeling and conveying, from peripheral zones of the cell, water sprayed onto the shelf with holes and for allowing it to fall above the hole of the respective housing.

6. The single-piece tray according to claim 1, wherein said hole of each cultivation cell has a substantially circular shape with a peripheral notch.

7. The single-piece tray according to claim 1, wherein said first volume and second volume of the buoyant portion of each cell are defined so that the sum of said first height and said second height is comprised between 25 mm and 40 mm.

8. The single-piece tray according to claim 1, wherein said first volume, second volume and third volume of the buoyant portion of each cell are defined so that said first height and said second height are comprised between 6 mm and 8 mm.

9. The single-piece tray according to claim 1, wherein the housing is at least partially enclosed between protruding elements which extend upwards from the shelf with holes of the tray.

10. The single-piece tray according to claim 9, wherein the protruding elements are separate from each other.

11. The single-piece tray according to claim 10, wherein said protruding elements are situated opposite each other relative to the housing.

12. The single-piece tray according to claim 1, realized as a single piece of plastic by means of a blow-moulding process.

13. The single-piece tray according to claim 1, wherein said channel is defined by an indentation or recess or niche which extends from the side of said lowered plane from the housing towards the edge of the single-piece tray.

14. The single-piece tray according to claim 1, wherein said single-piece tray is a body in the form of a closed tank.

15. A method of using the single-piece tray according to claim 1, during hydroponic cultivation, comprising:
placing the tray on water, so that
a first inner volume of the single-piece tray remains below the waterline as soon as the bulb or seedling to be cultivated is placed in the cultivation cell,
a second inner volume of the single-piece tray remains above the waterline when the bulb or seedling to be cultivated is placed in the cultivation cell and sinks below the waterline completely when the bulb or seedling to be cultivated has become a mature plant,
a third inner volume of the single-piece tray remains above the waterline when the bulb or seedling to be cultivated has become a mature plant; and the venting of carbon dioxide inside the channel is permitted.

16. A method for hydroponic cultivation according to which seedlings or bulbs to be cultivated are housed inside cultivation cells of a single-piece tray,
wherein each cultivation cell includes a housing and a buoyant portion, wherein each housing defines a raised plane and is configured to house a bulb or seedling to be cultivated, said housing having a hole with dimensions such as to support the bulb or seedling to be cultivated without allowing it to fall through, while allowing its roots to protrude below the single-piece tray; and wherein the buoyant portion defines a lowered plane and is delimited by side walls which extend upwards from the lowered plane and are connected to said raised plane,
the method comprising placing said single-piece tray inside a tank containing water so that:
a first inner volume of the single-piece tray with a first height remains below the waterline when the bulb or seedling to be cultivated is placed in the cultivation cell,
a second inner volume of the single-piece tray with a second height remains above the waterline when the bulb or seedling to be cultivated is placed in the cultivation cell and sinks below the waterline completely when the bulb or seedling to be cultivated has become a mature plant;
a third inner volume of the single-piece tray with a third height remains above the waterline when the bulb or seedling to be cultivated has become a mature plant;
wherein the sum of said first height, second height and third height corresponds to a height of the side walls of the single-piece tray between said raised plane and said lowered plane and wherein said side walls form a channel which allows the passage of gas or venting between each housing and a space outside the single-piece tray.
